(19) United States
(12) Patent Application Publication
(10) Pub. No.: US 2026/0148541 A1
(43) Pub. Date: May 28, 2026

(54) SYSTEMS AND METHODS FOR TRAINING A MULTI-MODAL LANGUAGE MODEL WITH REASONING

(71) Applicant: Salesforce, Inc., San Francisco, CA (US)

(72) Inventors: Zhiwei Liu, Austin, TX (US); Zixian Ma, Palo Alto, CA (US); Jianguo Zhang, San Jose, CA (US); Juntao Tan, Palo Alto, CA (US); Jieyu Zhang, Palo Alto, CA (US); Manli Shu, Greenbelt, MD (US); Shelby Heinecke, San Francisco, CA (US); Huan Wang, Palo Alto, CA (US); Caiming Xiong, Menlo Park, CA (US); Silvio Savarese, Palo Alto, CA (US)

(21) Appl. No.: 19/196,487

(22) Filed: May 1, 2025

Related U.S. Application Data
(60) Provisional application No. 63/726,169, filed on Nov. 27, 2024.

(51) Int. Cl. G06V 10/82; G06V 10/774; G06V 20/70

(52) U.S. Cl. CPC G06V 10/82; G06V 10/774; G06V 20/70

(57) ABSTRACT

Embodiments described herein provide a training framework with a data pipeline to generate synthesized multi-modal queries with chain-of-thoughts-and-action data for training a multi-modal language model. Specifically, given an image and question-answer (QA) pair as input, a multi-modal language model is prompted to generate a chain-of-thoughts-and-action (CoTA) output corresponding to the answer. The generated CoTA is then used as an input to guide the multi-modal language model to generate an answer to the question, so as to verify whether the CoTA is accurate. Additionally, the CoTA may be parsed into a sequence of actions in order to verify whether the parsed sequence actions leads to the correct answer. After the verification of the CoTA, the CoTA may be added to the image and the QA pair as training data to further train a multi-modal language model to generate an answer according to an input image.

### CROSS-REFERENCE

The instant application is a nonprovisional of and claims priority to U.S. provisional patent application No. 63/726,169, filed Nov. 27, 2024, which is hereby expressly incorporated by reference herein in its entirety.

### TECHNICAL FIELD

The embodiments relate generally to machine learning systems for multi-modal language models, and more specifically to training a multi-modal language model with reasoning.

### BACKGROUND

AI agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Some generative language model may receive an input of different format, such as an image, a video, a text and/or the like, and generate a response, referred to as “multi-modal language models.” For example, an AI agent may receive a medica image and a question associated with the medical image and generate a response providing diagnostic information based on the medical image. However, existing multi-modal language models are unable to provide reasoning and/or explanations on how and why any diagnostics is made based on the medical image. Training a multi-modal language model to provide reasoning that arrives at its output answer is challenging due to the massive space of different types and/or domains of multi-modal tasks.

### BRIEF DESCRIPTION OF THE DRAWINGS

FIG. 1A shows an example operation of an LLM based AI agent, according to embodiments of the present disclosure.

FIG. 1B-1E provide example UI diagrams illustrating the responses of the AI agent at the AI agent UI, according to embodiments described herein.

FIG. 2A is a simplified diagram illustrating a data generation pipeline for generating training CoTA traces for the multi-modal AI agent described in FIG. 1A, according to embodiments described herein.

FIG. 2B is a simplified diagram illustrating a data generation pipeline for generating training CoTA traces for the multi-modal AI agent described in FIG. 1A, according to embodiments described herein.

FIG. 3 is a simplified diagram illustrating a computing device implementing the multi-modal agent described in FIGS. 1-2B, according to some embodiments.

FIG. 4 is a simplified diagram illustrating a neural network structure, according to some embodiments.

FIG. 5 is a simplified block diagram of a networked system suitable for implementing the multi-modal LLM framework described in FIGS. 1-4 and other embodiments described herein.

FIG. 6 is an example logic flow diagram illustrating a method of training a neural network model for generating a response with reasoning to a question based on an input image based on the framework shown in FIGS. 1-5, according to some embodiments described herein.

FIGS. 7-9 provide example performance charts of multi-modal models trained by the training data generated by the data pipelines described in FIGS. 1A-6.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

AI agents, commonly known as chatbots or virtual assistants, can be applied to a wide range of practical applications across various industries, and sometimes may involves multiple inputs from users, such as an image, a video, and/or the like. The space of real-world multimodal tasks is vast, encompassing everything from basic question answering to complex, multi-step mathematical reasoning. An example involves a user taking a photo of a gas station price board and asking an AI agent how much gasoline they can purchase with a given budget. Solving this problem requires accurate extraction of text from the image, spatial understanding of the layout of the image, and numerical reasoning based on the extracted data. While existing multimodal language models (MLLMs) may succeed in perception-based tasks (such as image captioning, object localization and identification, etc.), existing MLLMs often fail to generalize to scenarios requiring structured, multi-step reasoning (such as mathematical reasoning on figuring out the amount of gas to purchase) over visual and textual inputs.

Embodiments described herein provide a training framework with a data pipeline to generate synthesized multi-modal queries with chain-of-thoughts-and-action data for training a multi-modal language model. Specifically, given an image and question-answer (QA) pair as input, a multi-modal language model is prompted to generate a chain-of-thoughts-and-action (CoTA) output corresponding to the answer. The generated CoTA is then used as an input to guide the multi-modal language model to generate an answer to the question, so as to verify whether the CoTA is accurate. Additionally, the CoTA may be parsed into a sequence of actions in order to verify whether the parsed sequence actions leads to the correct answer. After the verification of the CoTA, the CoTA may be added to the image and the QA pair as training data to further train a multi-modal language model to generate an answer according to an input image.

For example, to efficiently construct a large-scale CoTA dataset, two main pipelines may be employed: one using GPT-4o for prompt-based generation, and another using Python-based template-based programs. The combined process yields a number of CoTA traces (e.g., 815K from GPT-4o across 31 image datasets and over 1M traces from scripted generation). The generated CoTA data is then filtered and mixed using various heuristic and programmatic techniques. From this pool, nine data composition strategies (“recipes”) are defined. These recipes are evaluated across three open-source multimodal models, varying in both language models (Qwen2, LLaMA3) and vision encoders (CLIP, SigLIP). After experimentation, the most effective recipe may be selected, resulting in a curated subset of 293K high-quality CoTA traces. This final data dataset is used to train a family of multimodal action models.

In this way, the multi-modal language model may be trained by the CoTA dataset to improve reasoning ability in visual-language tasks that require multiple steps of logic reasoning and executions. Multi-modal language model technology is thus improved.

### Overview

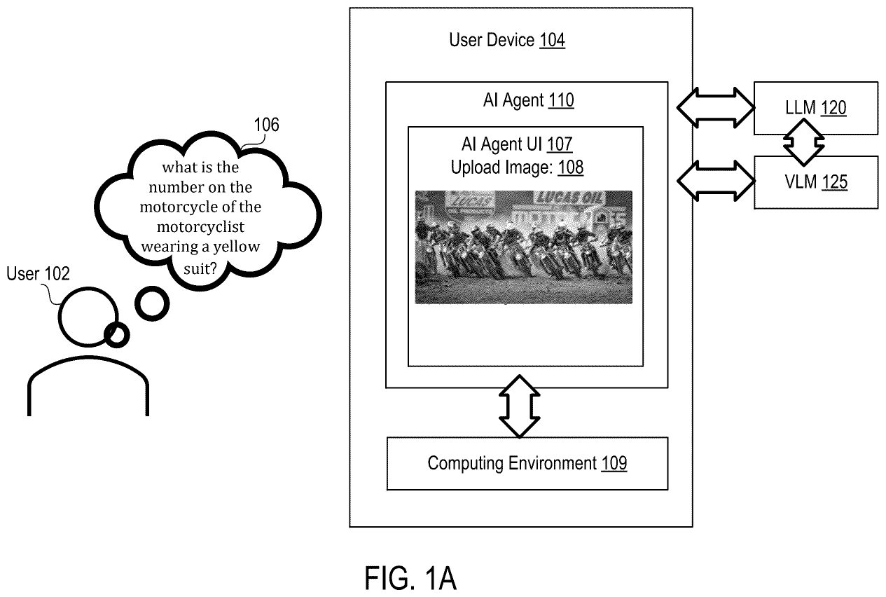

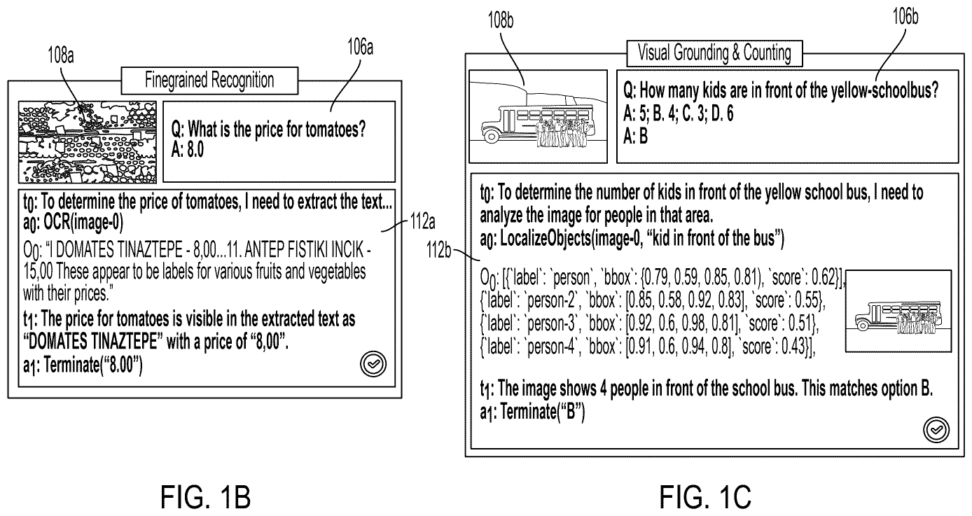

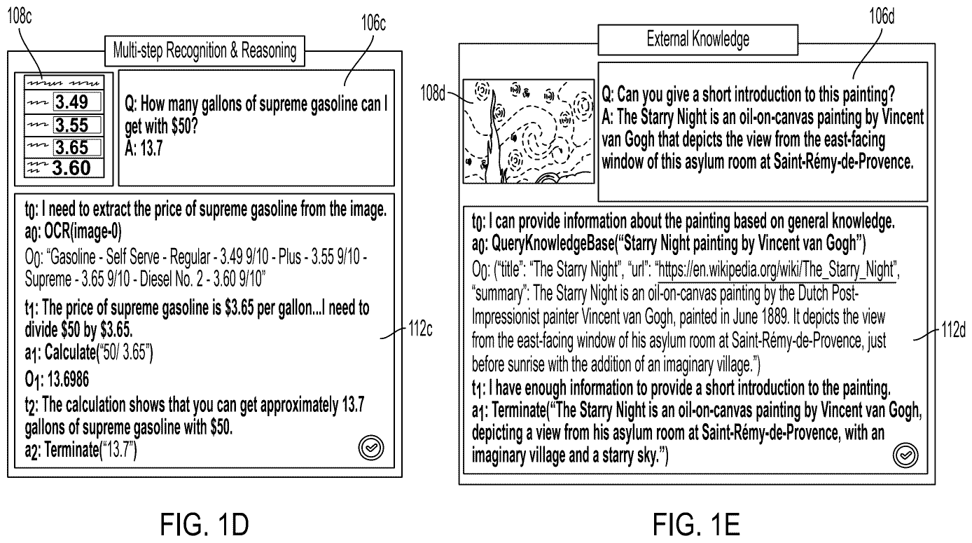

FIG. 1A shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may upload an image 108 with a text request 106 to ask the AI agent 110 to address the text request based on the input image 108.

In one embodiment, the AI agent 110 may processes the task request 106 at an LLM 120 and/or vision-language model (VLM) 125 to understand its intent, extracting key information such as the task type, desired outcome, and any specific constraints in order to generate a response. The LLM 120 and/or the VLM 125 may be hosted at an external server, a cloud service, and/or the like that is accessible by a communication network. In a different implementation, the LLM 120 and/or the VLM 125 may be hosted on the user device 104. An input to the LLM 120 and/or the VLM 125 may comprise the task request 106 and instruction provided to the LLM 120 and/or the VLM 125 to guide its behavior or responses in a particular way, referred to as a “system prompt.” For example, the system prompt may contain instruction for the LLM 120 and/or the VLM 125 to analyze the input text based on the image and respond according to the request identified in the input, and generate an output in a certain format, e.g., suggested code program, text description, etc.

In one embodiment, in response to the multi-modal task request 106 and the input image 108, instead of merely generating a final answer or solution, the AI agent 110 may generate Chain-of-Thought-and-Action (CoTA) traces including a sequence of intermediate reasoning steps and tool executions. For example, a chain-of-thought-and-action C may include a sequence of steps Si, where each step consists of thought tᵢ, action aᵢ and observation oᵢ:

$$C = ( {S}_{0} , {S}_{1} , … , {S}_{n} ) = {( {S}_{i} )}_{i = 0}^{n} \qquad ( 1 )$$

$${S}_{i} = ( {t}_{i} , {a}_{i} , {o}_{i} ) , {t}_{i} ∈ L , a , ∈ A \qquad ( 2 )$$

where L represents the space of language, and A is the action space as described next. Note that the model only generates tᵢ and aᵢ, where the training loss is applied on, whereas oᵢ is obtained by executing aᵢ, e.g., in Python code.

In one embodiment, the action space A of the multi-modal action model (e.g., a combination of LLM 110 and VLM 120) may be pre-defined as a set of atomic tools designed to support multi-step, multi-modal tasks. These tools are selected from a consolidated set of commonly used components in multimodal tool-use systems, with standardized naming and flexible input/output handling. An example set includes 15 tools: OCR, GETOBJECTS, LOCALIZEOBJECTS, ESTIMATEOBJECTDEPTH, ESTIMATEREGIONDEPTH, GETIMAGETOTEXTSSIMILARITY, GETIMAGETOIMAGESSIMILARITY, GETTEXTTOIMAGESSIMILARITY, DETECTFACES, CROP, ZOOMIN, QUERYLANGUAGEMODEL, QUERYKNOWLEDGEBASE, CALCULATE, and SOLVEMATH EQUATION. Most tools are vision-centric or visual-linguistic, while the last four support language-based reasoning and retrieval. A TERMINATE action is also included to signal the end of execution and output the final answer.

For example, given the multimodal input—such as the image 108 and the natural language request 106—the agent 110 may first parse the visual content (e.g., through OCR or object detection) and identify relevant entities or regions. The AI agent 110 then generates executable code, such as Python code or other system-level command code, of an action plan consisting of explicit operations, such as invoking a calculator for numerical reasoning or calling an OCR engine to extract specific text regions. At each step, the agent 110 logs its internal thought process and the external tool's output, producing a structured trace that interleaves reasoning (“thought”) and tool invocations (“action”). This trace may serve both as a training signal and as a transparent explanation of how the agent arrives at its final answer.

In this way, the CoTA output makes the model's reasoning process explicit, allowing for greater transparency and easier debugging. Instead of just giving a final answer, the AI agent 110 shows each step it took-what it observed, how it interpreted it, and which tools it used-making the output more trustworthy and adaptable to complex, multi-step tasks.

FIG. 1B-1E provide example UI diagrams illustrating the responses of the AI agent 110 at the AI agent UI 107, according to embodiments described herein. For example, as shown in FIG. 1B, a task request 106a related to finegrained recognition of input image 108a may be received. To address the finegrained recognition task request 106a, the AI agent 110 may generate CoTA 112a, such as “extracting the text,” performing OCR on the input image, and/or the like.

For another example, as shown in FIG. 1C, a task request 106b related to visual grounding and counting of an object in input image 108b may be received. To address the visual grounding and counting task request 106b, the AI agent 110 may generate CoTA 112b, such as a thought of “analyzing the image of people in the area,” an action of localizing the object on the input image, and/or the like.

For another example, as shown in FIG. 1D, a task request 106c related to multi-step recognition and reasoning of input image 108c may be received. To address the multi-step recognition and reasoning task request 106c, the AI agent 110 may generate CoTA 112c, such as a thought of first “extracting the price of supreme gasoline from the image,” an action of performing OCR on the input image, then a thought of calculations, and then an action of performing a series of calculation logics and reasoning, and/or the like.

For another example, as shown in FIG. 1E, a task request 106d related to external knowledge to process input image 108c may be received. To address the external knowledge task request 106d, the AI agent 110 may generate CoTA 112d, such as a thought of first “providing information about the painting based on general knowledge,” an action of querying a knowledge base, and/or the like.

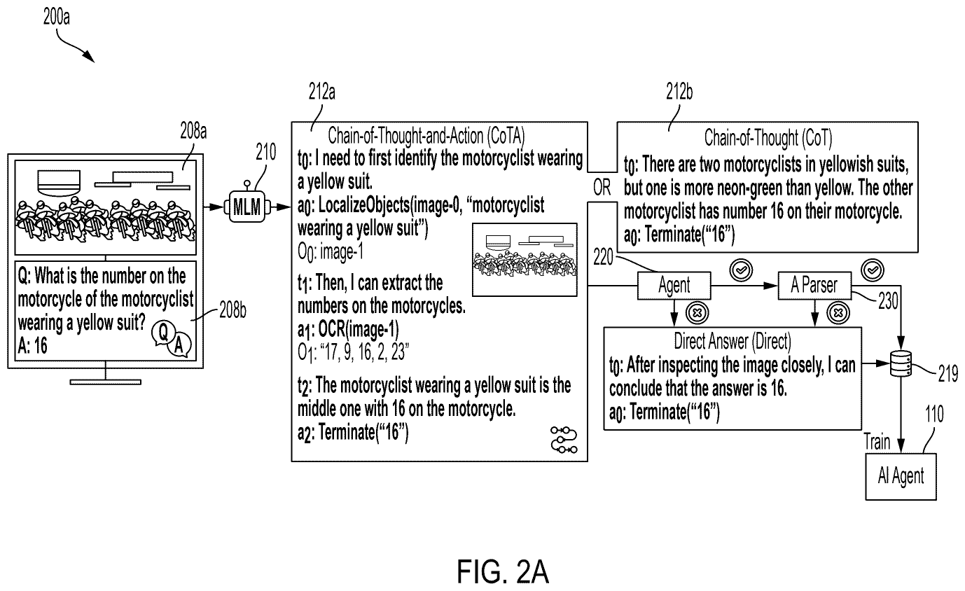

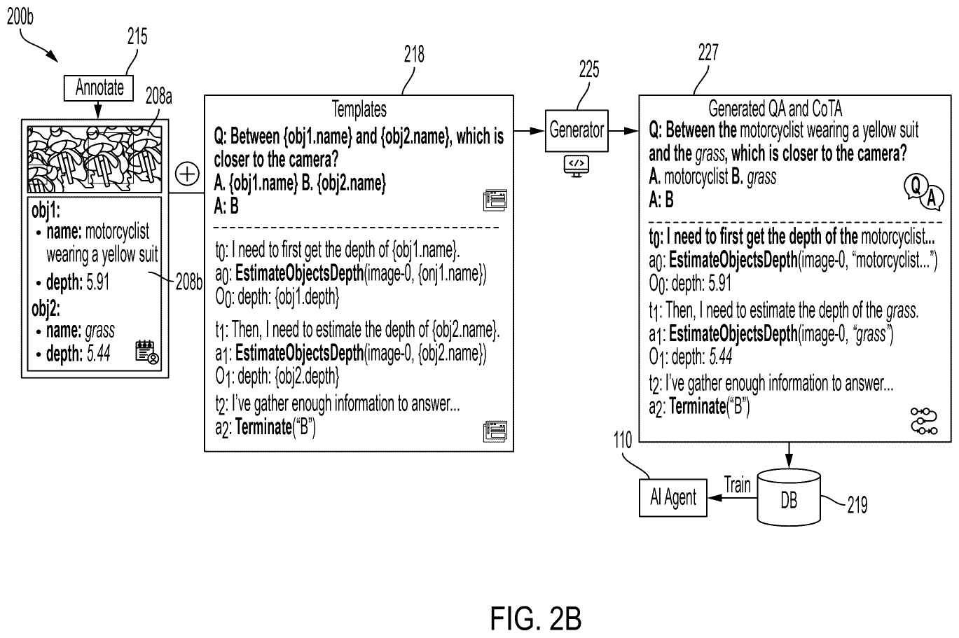

FIG. 2A is a simplified diagram illustrating a data generation pipeline 200a for generating training CoTA traces for the multi-modal AI agent 110 described in FIG. 1A, according to embodiments described herein. For example, the data generation pipeline 200a adopts a model-based generation method that generates large-scale synthetic CoTA data across diverse sources with different code programs. The generation pipeline 200a begins by retrieving visual question-answer pairs, e.g., an image 208a with a question-answer pair 208b, from a visual instruction tuning datasets. Each image-question pair 208b may be passed to a multi-modal LLM 210 (e.g., GPT-4o) to generate either a CoTA trace 212a or a simpler chain-of-thought (CoT) trace 212b, depending on the complexity and nature of the question.

For example, for tasks that require multiple reasoning steps or tool use, CoTA traces 212a are produced. For questions that are straightforward or outside the scope of available tools (e.g., those needing specialized domain knowledge), a plain CoT 212b is generated instead. The multi-modal LLM 210 may be prompted using a ReAct-style format, where tool invocations are expressed in structured JSON, and detailed examples and usage instructions are embedded in the prompt to guide behavior. An example prompt for the multi-modal LLM 210 to generate the CoTA or CoT traces may comprise examples of actions, thoughts, and/or the like, and may take a form similar to:

```
[BEGIN OF GOAL]
  You are a helpful assistant, and your goal is to solve the # USER REQUEST #. You can either rely on
your own capabilities or perform actions with external tools to help you. A list of all available
actions are provided to you in the below.
[END OF GOAL]
[BEGIN OF ACTIONS]
Name: OCR
Description: Extract texts from an image or return an empty string if no text is in the image. Note
that the texts extracted may be incorrect or in the wrong order. It should be used as a reference
only.
Arguments: {’ image’ : ’ the image to extract texts from.’ }
Returns: {’ text’ : ’ the texts extracted from the image.’ }
Examples: {″name″: ″OCR″, ″arguments″: {″image″: ″image-0″}}
Name: LocalizeObjects
Description: Localize one or multiple objects/regions with bounding boxes. This tool may output objects
that don' t exist or miss objects that do. You should use the output only as weak evidence for
reference. When answering questions about the image, you should double-check the detected objects.
You should be especially cautious about the total number of regions detected, which can be more or
less than the actual number.
Arguments: {’ image’ : ’ the image to localize objects/regions in.’ , ’ objects’ : ″a list of object
names to
localize. e.g. [’ dog’ , ’ cat’ , ’ person’ ]. the model might not be able to detect rare objects or
objects with complex descriptionriptions.″}
Returns: {’ image’ : ’ the image with objects localized and visualized on it.’ , ’ regions’ : “the
regions of interests localized in the image, where each region is represented by a dictionary with the
region's label text, bounding box and confidence score. The confidence score is between 0 and 1, where
1 means the model is very confident. Note that both the bounding boxes and confidence scores can be
unreliable and should only be used as reference.”}
Examples:
{″name″: ″LocalizeObjects″, ″arguments″: {″image″: ″image-0″, ″objects″: [″dog″, ″cat″]}}
Name: GetObjects
Description: Using this function to get objects in an image.
Arguments: {’ image’ : ’ the image to get objects from.’ }
Returns: {’ objects’ : ’ the objects detected in the image.’ }
  Examples: {″name″: ″GetObjects″, ″arguments″: {″image″: ″image-0″}}
...
[END OF ACTIONS]
```

```
[BEGIN OF TASK INSTRUCTIONS]
1. You must only select actions from # ACTIONS #.
2. You can only call one action at a time.
3. If no action is needed, please make actions an empty list (i.e. “actions”: [ ]).
4. You must always call Terminate with your final answer at the end.
[END OF TASK INSTRUCTIONS]
[BEGIN OF FORMAT INSTRUCTIONS]
Your output should be in a strict JSON format as follows:
{“thought”: “the thought process, or an empty string”, “actions”: [{“name”: “action1”, “arguments”: {“
argument1”: “value1”, “argument2”: “value2”}}]}
[END OF FORMAT INSTRUCTIONS]
[BEGIN OF EXAMPLES]:
# USER REQUEST #:
In image-0, Which of the two objects on the plate is the biggest?
A. The pile of scrambled eggs is the biggest.
B. The strawberries are the biggest object.
Please answer directly with only the letter of the correct option and nothing else.
  # RESPONSE #:
{“thought”: “To determine which of the two objects on the plate is larger, I need to analyze the size
of the scrambled eggs, and the strawberries”, “actions”: [{“name”: “LocalizeObjects”, “arguments”:
{“image”: “image-0”, “objects”: [“scrambled eggs”, “strawberries”]}}]}
OBSERVATION:
{“image”: “image-1”, “regions”: [{“label”: “eggs”, “bbox”: [0.5, 0.6, 0.6, 0.8], “score”: 0.85}, {“
label”: “strawberries”, “bbox”: [0.4, 0.5, 0.45, 0.7], “score”: 0.54}]}
  {“thought”: “To calculate the area of a bounding box, we can use the formula: area = (x_max − x_min) *
(y_max − y_min). We first get the area of the scrambled eggs.”, “actions”: [{“name”: “Calculate”, “
arguments”: {“expression”: “(0.6-0.5) * (0.8-0.6)”}}]}
...
[END OF EXAMPLES]
```

In one embodiment, once a CoTA trace 212a is generated, the final answer is extracted from the TERMINATE action and compared against the ground-truth answer provided in the original dataset to verify its correctness at 220, e.g., the answer in the question-answer pair 208b. If the predicted answer matches the ground-truth, the CoTA trace 212a is marked as valid and progresses to the next stage of parsing 230. If the final answer is incorrect, the CoTA trace 212a is discarded and the original question-answer pair is converted into a simpler format where only the direct answer is retained, without intermediate reasoning steps.

In one embodiment, each step of the valid CoTA trace 212a is parsed using json.loads( ). This ensures that the trace can be interpreted and executed programmatically. Traces that fail to parse correctly are again converted into direct-answer format, while successfully parsed CoTA traces 212a are retained as high-quality CoTA data. Therefore, the resulting CoTA traces 212a, the input image 208a, the question-answer pair 208b may be stored at a database 219, which may be in turn used to train the AI agent 110 to produce CoTA traces in response to a vision-language task. This multi-stage pipeline 200a filters out invalid or poorly structured traces and ensures that only well-formed, executable reasoning sequences are used for training.

FIG. 2B is a simplified diagram illustrating a data generation pipeline 200b for generating training CoTA traces for the multi-modal AI agent 110 described in FIG. 1A, according to embodiments described herein. For example, the data generation pipeline 200b adopts a programmatic data generation method that first obtains dense annotations of images, and then generate both question and answer pairs and tool use trajectories with pre-defined templates.

In one embodiment, the generation process begins by collecting dense image annotations 208b for input images 208a. For example, the input image data 208a may be annotated by an annotator 215, such as a multi-modal LLM (GPT-4o), a human annotator, etc. The annotation 208b may comprise object categories, attributes, and inter-object relationships. Additionally, depth maps may be generated for input images 208a, e.g., using Depth-Anything-v2, as depth information may provide information for spatial reasoning tasks but challenging to annotate manually.

In one embodiment, using the collected annotations 208b with images 208a, QA pairs and their corresponding CoTA traces may be programmatically created using a pre-defined template 218. For example, the template may comprise data fields for “obj1.name” annotated in a specific input image, and/or the like. The QA generation pipeline may be adapted to cover a broad range of visual reasoning tasks such as counting and spatial inference. For each action step in a CoTA trace, predefined templates are used to structure thoughts, actions, and observations. Five distinct thought templates are authored per action type, and one is randomly selected during generation to introduce variability. The generator module 225 may determine which template to use based on a question type—for example, ESTIMATEOBJECTDEPTH for depth-related queries and LOCALIZEOBJECTS for counting tasks. Action templates are filled with the relevant annotations as inputs, while observation templates are constructed to match the expected output format and populated accordingly.

The generator module 225 may then populate the template 218 with annotated information 208b to generate the QA pairs and CoTA traces 227. This generation process yields structured, high-coverage CoTA traces with precise control over tool usage and task diversity.

In one embodiment, the generation pipelines 200a and 200b may thus generate a comprehensive dataset for training visual question answering models that incorporate action-based analysis techniques. For example, the resulting dataset 219 may comprise approximately 815,000 entries created using advanced vision-language models across 31 distinct data sources (that feed the original input images 208a). Additionally, the generation pipeline 200b may programmatically generate over 1 million question-answer pairs with corresponding CoTA data using visual genome images and annotations, which are randomly sampled to augment the model-generated data from generation pipeline 200a.

In one embodiment, the generated data from generation pipelines 200a-200b may follow specific structural formats, such as CoTA, CoT, and Direct answer formats. Examples in these formats may be further categorized based on answer correctness: positive examples (CoTA-pos, CoT-pos) contain correct final answers, while negative examples (CoTA-neg, CoT-neg) contain incorrect answers. The negative examples are converted to Direct format with corrected ground truth answers. Various combinations of these formats may be used in training the AI agent 110, including CoTA-only datasets, CoTA and CoT combinations, CoTA and Direct combinations, and comprehensive datasets containing all three formats.

In one embodiment, the generation pipelines 200a-b may adopt source-based filtering mechanisms to optimize performance. Data sources are classified as either “Action-useful” or “Action-useless” based on specific metrics. A data source is considered Action-useless if the model either produces only thoughts significantly more often than both thoughts and actions (with a differential threshold exceeding 10%), or reaches incorrect answers substantially more frequently than correct ones when invoking actions (with a similar threshold).

In one embodiment, to address the imbalance in action distribution within model-generated data, where certain actions like GETOBJECTS and OCR are disproportionately represented, the generation pipelines 200a-b may incorporate programmatically generated data that emphasizes underrepresented actions such as LOCALIZEOBJECTS, ESTIMATEOBJECTDEPTH, and ESTIMATEREGIONDEPTH. Various mixture ratios of model-generated to program-generated data are tested, ranging from 1:1 to 1:0.1.

In one embodiment, the generated dataset 210 may be used to train an AI agent 110 on vision-language task with reasoning. For example, the CoTA traces may serve as structured training data for multi-modal Large Language Model optimization, wherein each trace comprises a sequence of reasoning steps interspersed with executable visual processing operations. During model training, these traces function as exemplars that facilitate the acquisition of visual-linguistic reasoning patterns through supervised learning mechanisms. The training process implements gradient-based optimization to minimize the divergence between predicted and reference CoTA sequences, thereby teaching the model to: (1) determine appropriate junctures for visual operation invocation, (2) select optimal visual functions from the available operation set, (3) parse and integrate operation outputs into its reasoning framework, and (4) synthesize conclusions based on the aggregated multi-modal information. This methodology enables the model to develop modular reasoning capabilities where visual perception functions are strategically deployed within the broader inferential process.

### Computer and Network Environment

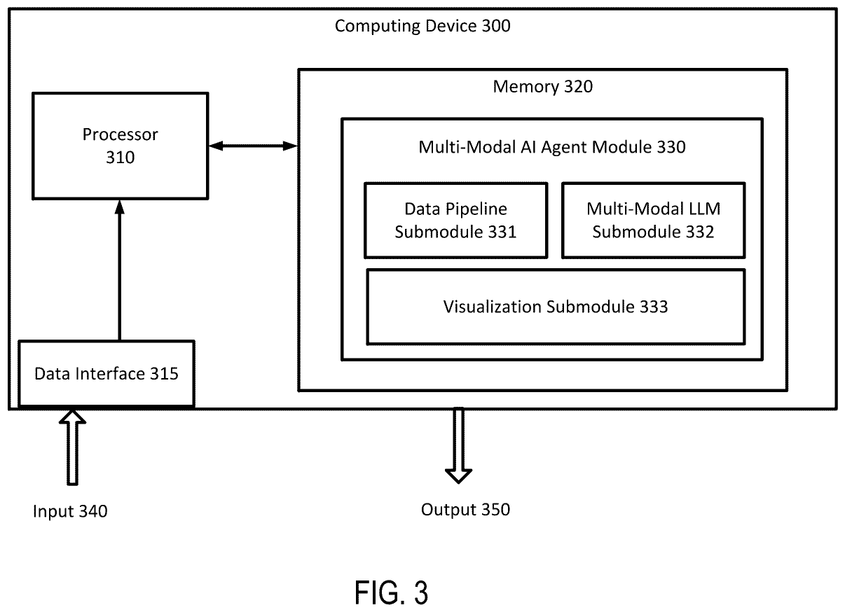

FIG. 3 is a simplified diagram illustrating a computing device implementing the multi-modal AI agent described in FIG. 1, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for multi-modal AI agent module 330 that may be used to implement and/or emulate the systems and models, and/or to implement any of the methods described further herein. multi-modal AI agent module 330 may receive input 340 such as an input training data (e.g., as generated in FIG. 2) via the data interface 315 and generate an output 350 which may be a response to a question based on an input image.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as a question and an input image, from a user via the user interface.

In some embodiments, the multi-modal AI agent module 330 is configured to conduct a conversation with a user based on multi-modal user input. The multi-modal AI agent module 330 may further include data pipeline submodule 331 (e.g., similar to 200a-b in FIGS. 2A-2B), multi-modal LLM submodule 332 and visualization submodule 333.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

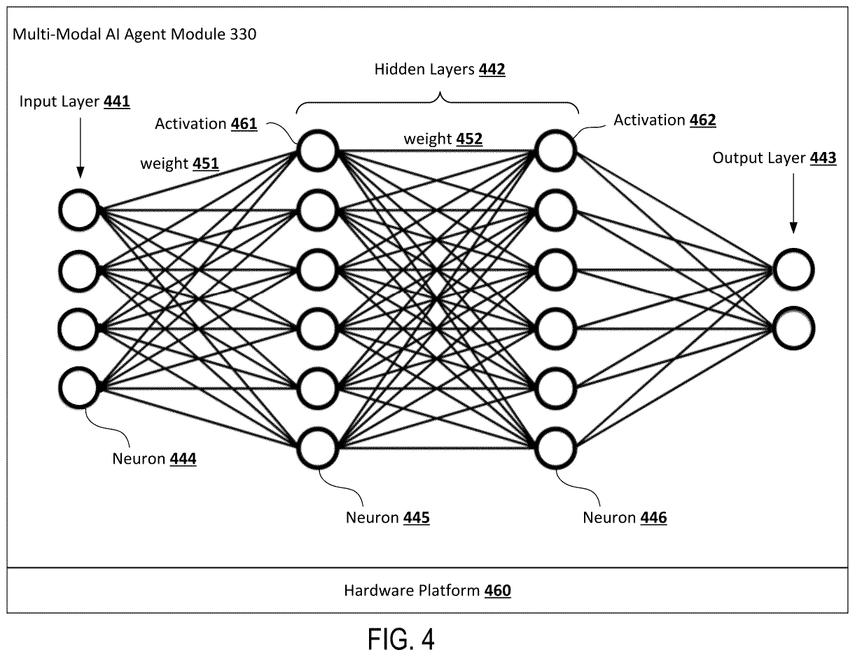

FIG. 4 is a simplified diagram illustrating the neural network structure implementing the multi-modal AI agent module 330 described in FIG. 3, according to some embodiments. In some embodiments, the multi-modal AI agent module 330 and/or one or more of its submodules 331-333 may be implemented at least partially via an artificial neural network structure shown in FIG. 4. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a text question and/or an input image. The number of nodes (neurons) in the input layer 341 may be determined by the dimensionality of the input data (e.g., the length of a vector of an input question). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the multi-modal AI agent module 330 receives an input 340 of an input question and/or an input image and transforms the input into an output 350 of an answer to the question. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the multi-modal AI agent module 330 and/or one or more of its submodules 331-333 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be GPT-4o, and/or the like.

In one embodiment, the multi-modal AI agent module 330 and its submodules 331-333 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the multi-modal AI agent module 330 and its submodules 331-333 may be implemented by hardware, software and/or a combination thereof. For example, the multi-modal AI agent module 330 and its submodules 331-333 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the multi-modal AI agent module 330 and its submodules 331-333 and/or any other neural network models such as VLM 125 described in FIG. 1 onto hardware platform 360, the neural network based modules 330 and its submodules 331-333 may be optimized for deployment by converting it to a suitable format, such as ONNX or TensorRT, to improve performance and compatibility. Next, depending on the size and workload requirements for modules 330 and its submodules 331-333, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the multi-modal AI agent module 330 and its submodules 331-333 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the multi-modal AI agent module 330 and its submodules 331-333 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the multi-modal AI agent module 330 and its submodules 331-333 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the multi-modal AI agent module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based multi-modal AI agent module 330 and one or more of its submodules 331-333 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as those generated from FIG. 2 are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding to a question based on a training image) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based multi-modal AI agent module 330 and one or more of its submodules 331-333 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

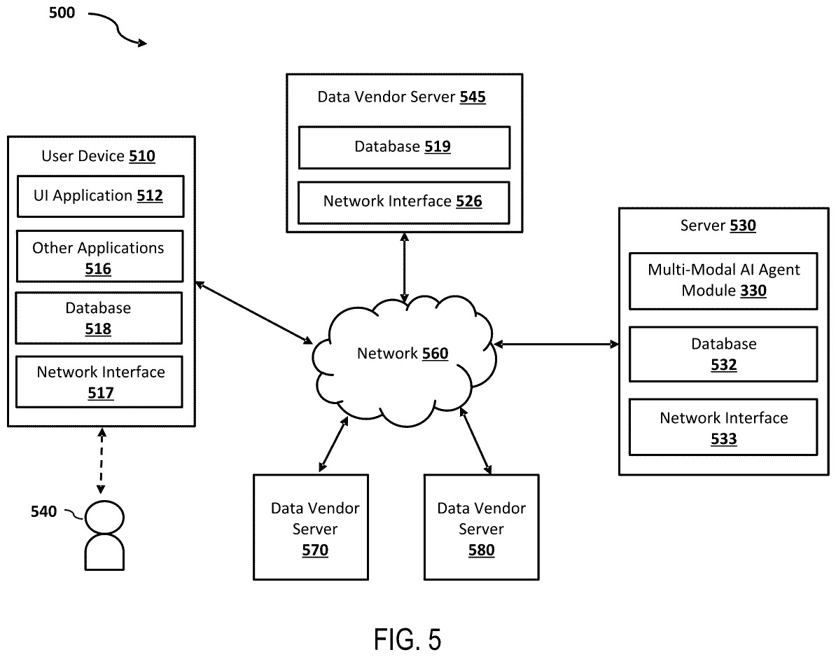

In some embodiments, multi-modal AI agent module 330 and its submodules 331-333 may be housed at a centralized server (e.g., computing device 300) or one or more distributed servers. For example, one or more of multi-modal AI agent module 330 and its submodules 331-333 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as a question on a medical image.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in digital image processing.

FIG. 5 is a simplified block diagram of a networked system 500 suitable for implementing the multi-modal AI agent framework described in FIGS. 1-4 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating the answer to a visual query from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the multi-modal AI agent module 330 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which multi-modal AI agent module 330 may generate a response via the process described in FIGS. 1-4. The multi-modal AI agent module 330 may thus cause a display of a question, an answer and an input image in a chat format at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the result.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including question, answer and training images shown in FIG. 2 to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the multi-modal AI agent module 330 and its submodules described in FIG. 3. In some implementations, multi-modal AI agent module 330 may receive data from database 519 at the data vendor server 545 via the network 560 to generate an answer to a question. The generated answer may also be sent to the user device 510 for review by the user 540 via the network 560.

In one embodiment, an AI agent implementing the multi-modal AI agent module 330 and its submodules described in FIG. 3 may be built based on an LLM as described in FIG. 4. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the multi-modal AI agent module 330 and its submodules described in FIG. 3 may be implemented as a cloud-based AI agent which may be accessed by user device 510 via a chatbot application, a web application, customer support or SaaS applications. In another implementation, a client-side AI agent component may be delivered from the server 530 to user device 510 for local installation such that the client-side AI agent may be installed and runs directly on the user's device. Such local AI agent on the user device 510 may be available offline to adapt to privacy-sensitive applications. In another implementation, the AI agent implementing the multi-modal AI agent module 330 and its submodules described in FIG. 3 may adopt a hybrid cloud and client-based structure to balance computing speed, cost and privacy. For example, a local AI agent may handle basic AI queries locally, but complex queries may be sent to server 530 to process.

The database 532 may be stored in a transitory and/or non-transitory memory of the server 530. In one implementation, the database 532 may store data obtained from the data vendor server 545. In one implementation, the database 532 may store parameters of the multi-modal AI agent module 330. In one implementation, the database 532 may store previously generated training data as shown in FIG. 2, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

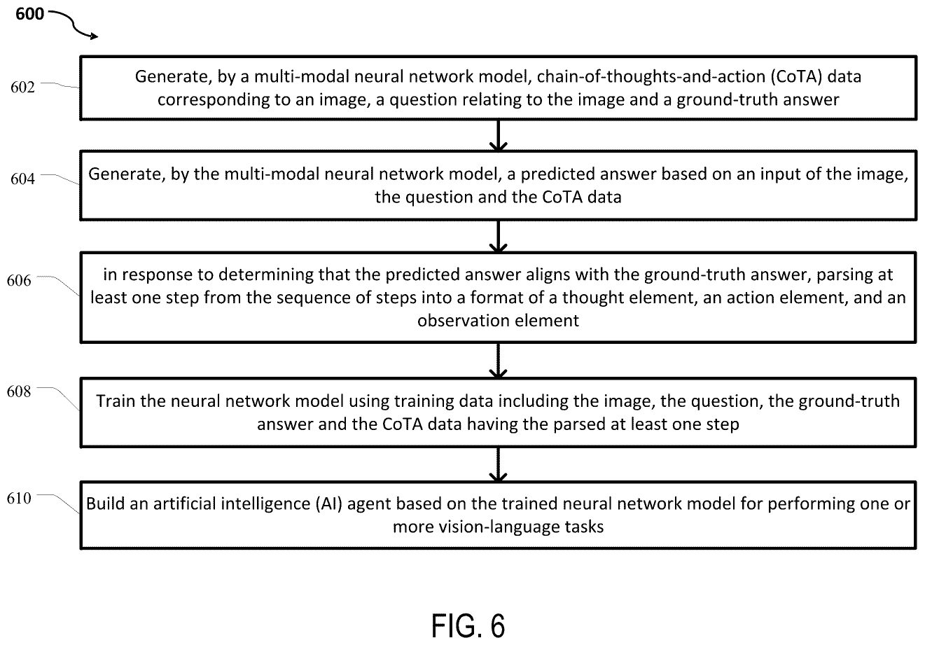

FIG. 6 is an example logic flow diagram illustrating a method of training a neural network model for generating a response with reasoning to a question based on an input image based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the multi-modal AI agent module 330 (e.g., FIGS. 3 and 5) that performs generating a response to a question with reasoning based on an input image.

In some embodiments, method 600 is performed by a system such as computing device 300, user device 510, server 530, or another device or combination of devices. Inputs (e.g., an image, a text question, etc.) may be received via a data interface such as data interface 315, network interface 517, network interface 533, or via a data interface that is integrated with a device. For example UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a multi-modal neural network model (e.g., LLM 120 and VLM 125 in FIG. 1A) may generate chain-of-thoughts-and-action (CoTA) data (e.g., 212a in FIG. 2A) corresponding to an image (e.g., 208a in FIG. 2A), a question relating to the image and a ground-truth answer (e.g., 208b in FIG. 2A). For example, the CoTA data includes a sequence of steps for execution towards the answer. For example, step 602 further includes generating CoTA data or Chain-of-Thoughts (CoT) data by the multi-modal neural network model, depending on the type of question. Each step of the CoTA data comprises a respective thought explaining what to do next, a respective action on how to implement the thought, and an observation of the computing environment after the action is carried out. Each step of the CoT data comprises the respective thought and the respective action.

At step 604, the multi-modal neural network model may then generate a predicted answer based on an input of the image, the question and the CoTA data. For example, the multi-modal neural network may follow the sequence of steps in the CoTA data to arrive at the predicted answer. For example, step 604 includes extracting the predicted answer from the CoTA data based on a final action indicator, e.g., “TERMINATE.”

At step 606, in response to determining that the predicted answer aligns with the ground-truth answer, at least one step may be parsed from the sequence of steps into a format of a thought element, an action element, and an observation element. For example, step 606 further includes excluding the CoTA data from the training data if the predicted answer does not align with the ground-truth answer or if the CoTA data fails to be parsed.

For example, method 600 further includes generating annotations for the image by the multi-modal neural network model. The annotations may comprise one or more of the following: an object category, an object attribute, an inter-object relationship, and a depth map. The method further includes generating a question-and-answer (QA) pair and corresponding CoTA data based on the annotations using a pre-defined template.

At step 608, the multi-modal neural network model may be trained using training data including the image, the question, the ground-truth answer and the CoTA data having the parsed at least one step. For example, step 608 further includes generating predicted CoTA data that leads to a training answer based on a training input of the question and the image. The training process involves using the predicted CoTA data and the CoTA data, and/or the training answer and the ground-truth answer.

At step 610, an artificial intelligence (AI) agent (e.g., 110 in FIG. 1A) may thus be built based on the trained multi-modal neural network model for performing one or more vision-language tasks (e.g., as shown in FIGS. 1B-1E).

In some embodiments, method 600 is applicable in a variety of applications. For example, the task request received by a neural network model (e.g., LLM 110 and VLM 125) may relate to a diagnostic request in view of a medical image in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 600 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

For another example, in the context of autonomous driving, the trained multi-modal agent (e.g., 110 in FIG. 1A) may generate CoTA traces by sequentially reasoning over camera images, LiDAR data, and navigation instructions. For instance, the agent may first detect and localize traffic signs, estimate the distance to nearby vehicles, and interpret lane markings using visual tools. It can then combine these observations with map-based instructions to determine the appropriate driving action, such as slowing down, changing lanes, or stopping, and provide reasoning on why such driving action is taken at each step. By explicitly recording each reasoning step and corresponding tool invocation, the generated CoTA trace provides a transparent and interpretable decision-making process that enhances both safety and debuggability in real-world driving scenarios.

### Example Results

Example experiments are conducted using three open-source multi-modal models and nine data recipes across eight diverse benchmarks to evaluate the impact of CoTA (Chain-of-Thought-and-Action) data. The objective is to assess its effectiveness compared to conventional instruction-tuning data with direct answers and to determine whether data filtering and programmatic augmentation contribute to further performance improvements.

The models (e.g., LLM 110 or VLM 125) tested include Mantis-8B-SigLIP-LLaMA-3 (based on LLaMA3-8B and SigLIP), Mantis-8B-CLIP-LLaMA-3 (LLaMA3-8B and CLIP), and LLaVA-OneVision-7B (Qwen2-7B and SigLIP), representing a range of combinations of language models and vision encoders. Training is performed using fine-tuning techniques on models initialized from different stages: pretrained and instruction-tuned checkpoints for Mantis variants, and stage 1 and 1.5 for LLaVA-OneVision-7B. The training is conducted using a learning rate of 1e-5 for one epoch, fine-tuning both the language model and visual projector components, utilizing NVIDIA A100 (40 GB) or H100 (80 GB) GPUs. Hyperparameter tuning is conducted primarily on LLaVA-OneVision-7B, adjusting vision encoder tuning, language model learning rates, and epoch count.

Baselines are established by training the same models on data with identical content but formatted as Direct answers rather than CoTA. These are compared against the few-shot performance of instruction-tuned Mantis, LLaVA-OneVision at stage 1.5, and GPT-4o.

Evaluation is performed on eight benchmarks targeting various multi-modal capabilities. Vision-centric question answering tasks included MMVet, MMVP, RealWorldQA, A-OKVQA, and BLINK, with BLINK featuring multi-image questions. MathVista was included to assess visual mathematical reasoning, while MMMU and MMStar evaluated general multi-modal reasoning. Evaluation metrics utilized VLMEvalKit, where ChatGPT-0125 extracted answers from multiple-choice prompts, and GPT-4-turbo acted as a scoring judge for open-ended responses, providing normalized scores from 0 to 1 relative to groundtruth.

Table 1 demonstrates that open-source multi-modal models fail to call external actions with few-shot prompting, despite proprietary models like GPT-4o performing this task effectively.

TABLE 1
CoTa Inference before and after fine-tuning

| | Language/ | Train data/ | | | |
|---|---|---|---|---|---|
| | Vision | Inference | | | |
| Model | backbone | format | A-OKVQA | BLINK | MathVista |
| GPT-4o (2024 Aug. 6) | — | —/Direct | 88.4 | 64.7 | 60.5 |
| GPT-4o (language-only) | | —/CoTA | 89.9 | 63.2 | 59.0 |
| | | —/CoTA | 74.8 | 45.6 | 44.5 |
| Mantis- | LLaMA3-8B/ | —/Direct | 81.2 | 46.4 | 34.4 |
| instruction-tuned | SigLIP | —/CoTA | 0.5 | 0.0 | 20.0 |
| TACO | | CoTA293K/CoTA | 81.8 | 47.6 | 36.3 |
| LLaVA-OV-Stage1.5 | Qwen2-7B/ | —/Direct | 76.1 | 34.8 | 35.9 |
| TACO | SigLIP | —/CoTA | 25.7 | 8.8 | 21.5 |
| | | CoTA293K/CoTA | 85.9 | 49.9 | 41.9 |

| Model | MMMU | MMStar | MMVet | MMVP | RealWorldQA | Avg |
|---|---|---|---|---|---|---|
| GPT-4o (2024 Aug. 6) | 67.6 | 64.5 | 70.0 | 84.7 | 72.0 | 71.5 |
| GPT-4o (language-only) | 64.6 | 64.3 | 67.2 | 83.0 | 69.9 | 70.1 |
| | 54.1 | | 45.2 | 58.0 | 50.2 | 53.5 |
| Mantis- | 40.1 | 40.1 | 36.9 | 69.0 | 51.0 | 49.9 |
| instruction-tuned | 1.5 | 1.7 | 0.0 | 0.0 | 0.0 | 3.0 |
| TACO | 40.9 | 42.5 | 45.7 | 65.3 | 56.5 | 52.1 |
| LLaVA-OV-Stage1.5 | 36.1 | 39.1 | 32.3 | 63.7 | 54.1 | 46.5 |
| TACO | 21.2 | 26.7 | 7.2 | 40.5 | 37.5 | 23.6 |
| | 44.0 | 51.0 | 50.9 | 72.3 | 58.8 | 56.8 |

However, fine-tuning these open-source models with CoTA data successfully elicits their abilities to produce chains of thoughts and actions at inference time. The best CoTA data recipe results in a strong multi-modal action model (TACO) that consistently outperforms instruction-tuned baselines by 1-4% on average across 8 benchmarks, with significant gains on MMVet.

### Table 2: Performance Gains Across Different Model Checkpoints

Table 2 shows consistent gains in average accuracy across 8 benchmarks when three different multi-modal models are fine-tuned with the best data recipe (CoTA 293K), compared to instruction-tuned baselines trained with the same examples in Direct format.

TABLE 2
Performance Gains Across Different Model CheckPoints

| | Language/ | Start | Train data/ | | |
|---|---|---|---|---|---|
| | Vision | checkpoint/ | Inference | | |
| Model | backbone | Seen data | format | A-OKVQA | BLINK |
| Mantis | LLaMA3-8B/CLIP | Pretrained/558K | Direct 293K/Direct | 80.7 | 45.8 |
| TACO | | | CoTA 293K/CoTA | 81.1 | 49.6 |
| Mantis | LLaMA3-8B/SigLIP | Pretrained/558K | Direct 293K/Direct | 80.3 | 43.7 |
| TACO | | | CoTA 293K/CoTA | 824 | 47.8 |
| Mantis | | Instruction tuned/1.2M | Direct 293K/Direct | 81.1 | 46.7 |
| TACO | | | CoTA 293K/CoTA | 81.8 | 47.6 |
| LLaVA-OV | Qwen2-7B/SigLIP | Stage 1/558K | Direct 293K/Direct | 83.1 | 49.5 |
| TACO | | | CoTA 293K/CoTA | 84.5 | 49.6 |
| LLaVA-OV | | Stage 1.5/4.5M | Direct 293K/Direct | 85.5 | 50.3 |
| TACO | | | CoTA 293K/CoTA | 85.9 | 49.9 |

| Model | MathVista | MMMU | MMStar | MMVet | MMVP | RealWorldQA | Avg | Delta |
|---|---|---|---|---|---|---|---|---|
| Mantis | 33.1 | 42.2 | 36.7 | 28.9 | 62.7 | 52.3 | 47.8 | +3.5 |
| TACO | 36.6 | 42.8 | 40.8 | 45.2 | 63.3 | 51.1 | 51.3 | |
| Mantis | 31.1 | 40.4 | 40.5 | 33.0 | 63.3 | 51.8 | 48.0 | +3.6 |
| TACO | 34.9 | 40.3 | 44.6 | 45.2 | 64.0 | 53.7 | 51.6 | |
| Mantis | 36.2 | 40.7 | 40.7 | 29.7 | 68.3 | 54.8 | 49.8 | +2.3 |
| TACO | 36.3 | 40.9 | 42.5 | 45.7 | 65.3 | 56.5 | 52.1 | |
| LLaVA-OV | 38.4 | 45.6 | 42.3 | 33.0 | 69.7 | 55.3 | 52.1 | +2.3 |
| TACO | 41.8 | 45.3 | 44.5 | 48.9 | 66.7 | 53.6 | 54.4 | |
| LLaVA-OV | 42.4 | 46.1 | 50.1 | 39.3 | 73.6 | 57.8 | 55.6 | +1.2 |
| TACO | 41.9 | 44.0 | 51.0 | 50.9 | 72.3 | 58.8 | 56.8 | |

The CoTA data produces larger gains on certain benchmarks, with 10-15% improvements on MMVet and 1-3% increases on other benchmarks except for MMMU and MMVP, which experience up to 2-3% decreases. Additionally, Table 2 reveals that CoTA data leads to greater gains on pretrained model checkpoints from earlier stages compared to later stages: 3.5+% on Mantis-pretrained versus 2.3% on Mantis-instruction-tuned, and 2.3% on LLaVA-OV-Stage1 versus 1.2% on LLaVA-OV-Stage1.5.

TABLE 3
Data Format and Source Distribution Effect

| Data | Final data | | | | | | | | | | | | |
|---|---|---|---|---|---|---|---|---|---|---|---|---|---|
| source | format | Size | Model | A-OKVQA | BLINK | MathVista | MMMU | MMStar | MMVet | MMVP | RealWorldQA | Avg | Delta |
| All | Direct | 293K | Mantis-SigLIP | 80.3 | 43.7 | 31.1 | 40.4 | 40.5 | 33.0 | 63.3 | 51.8 | 48.0 | +3.6 |
| datasets | CoTA | | TACO | 82.4 | 47.8 | 34.9 | 40.3 | 44.6 | 45.2 | 64.0 | 53.7 | 51.6 | |
| | Direct | 580K | Mantis-SigLIP | 82.3 | 45.2 | 34.2 | 42.6 | 39.5 | 31.9 | 67.7 | 52.6 | 49.5 | +1.7 |
| | CoTA + | | TACO | 84.0 | 46.4 | 36.3 | 40.3 | 40.6 | 43.7 | 66.7 | 51.6 | 51.2 | |
| | CoT | | | | | | | | | | | | |
| | Direct | 528K | Mantis- | 79.7 | 46.7 | 34.0 | 39.4 | 40.7 | 28.3 | 65.0 | 52.2 | 48.2 | −0.6 |
| | CoTA + | | SigLIP | 79.1 | 45.3 | 34.0 | 40.1 | 38.0 | 33.3 | 61.0 | 50.5 | 47.7 | |
| | Direct | | TACO | | | | | | | | | | |
| | Direct | 815K | Mantis- | 81.0 | 46.9 | 35.0 | 39.9 | 39.7 | 29.5 | 66.7 | 54.5 | 49.1 | −0.9 |
| | CoTA + | | SigLIP | 81.4 | 45.2 | 33.8 | 39.7 | 38.3 | 33.1 | 64.7 | 50.1 | 48.3 | |
| | CoT + | | TACO | | | | | | | | | | |
| | Direct | | | | | | | | | | | | |
| Action- | Direct | 566K | Mantis- | 81.6 | 42.4 | 32.8 | 42.2 | 40.3 | 26.8 | 67.0 | 50.2 | 47.9 | +0.6 |
| useful | CoTA + | | SigLIP | 82.4 | 43.3 | 31.9 | 38.1 | 39.5 | 35.6 | 67.0 | 50.3 | 48.5 | |
| datasets | CoT + | | TACO | | | | | | | | | | |
| | Direct | | | | | | | | | | | | |

Table 3 presents the effects of different data filtering techniques for adjusting distribution of data formats and data sources. The 293K CoTA examples dataset yields the best absolute performance and the largest gains of 3.6% over the baseline. Adding CoT examples results in a smaller gain of 1.7%, even though the training data size nearly doubles. Combining CoTA and Direct examples harms model performance, likely because mixing in Direct examples weakens reasoning and action calling abilities. Table 3 also shows that including only Action-useful datasets—where GPT-4o frequently chooses to call actions and reaches correct final answers—improves average performance compared to the baseline, while including all data sources does not. A smaller set of 566K CoTA traces leads to better performance than a larger 815K dataset, indicating that data quality exceeds quantity in importance.

TABLE 4
Effects of Programmatically Generated Data

| | | Train | Total | | | | | | | | | | |
|---|---|---|---|---|---|---|---|---|---|---|---|---|---|
| Model | | data | size | A-OKVQA | BLINK | MathVista | MMMU | MMStar | MMVet | MMVP | RealWorldQA | Avg | Delta |
| Mantis-SigLIP | | Direct 293K | 293K | 80.3 | 43.7 | 31.1 | 40.4 | 40.5 | 33.0 | 63.3 | 51.8 | 48.0 | |
| TACO | M:P | M-CoTA/ | | | | | | | | | | | |
| | | P-CoTA | | | | | | | | | | | |
| | 0:1 | 0/293K | 293K | 34.3 | 37.4 | 17.3 | 31.9 | 30.4 | 0.0 | 48.3 | 40.7 | 30.0 | — |
| | 1:0 | 293/0K | | 82.4 | 47.8 | 34.9 | 40.3 | 44.6 | 45.2 | 64.0 | 53.7 | 51.6 | +3.6 |
| | 1:0.1 | 293/29K | 322K | 82.6 | 47.5 | 33.9 | 40.3 | 44.2 | 42.3 | 64.3 | 49.8 | 50.6 | +2.6 |
| | 1:0.25 | 293/73K | 366K | 82.1 | 44.2 | 38.3 | 40.2 | 42.9 | 45.1 | 64.7 | 51.2 | 51.1 | +3.1 |
| | 1:0.5 | 293/147K | 440K | 81.9 | 46.0 | 36.7 | 41.4 | 41.4 | 40.9 | 62.3 | 50.3 | 50.1 | +2.1 |
| | 1:1 | 293/293K | 586K | 81.1 | 47.7 | 31.0 | 39.3 | 41.4 | 36.2 | 63.0 | 50.7 | 48.8 | +0.8 |

Table 4 explores training with different mixtures of model-generated and program-generated data, with relative ratios varying from 1:0.1 to 1:1. Additional programmatic data brings gains on benchmarks such as AOKVQA, MathVista, MMMU, and MMVP. However, none of these data mixtures results in better average performance than the best model-generated data alone.

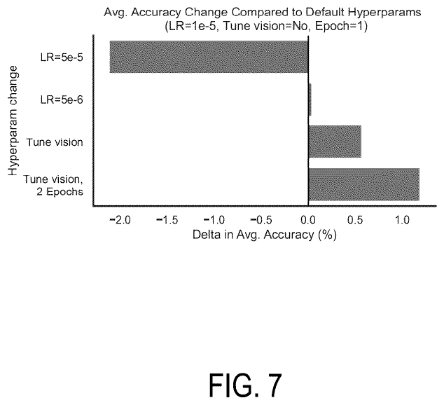

FIG. 7 indicates that further model improvements can be achieved through hyperparameter tuning experiments with LLaVa-OV-Stage1.5, specifically by tuning the vision encoder, training with a smaller learning rate, or extending training for more epochs.

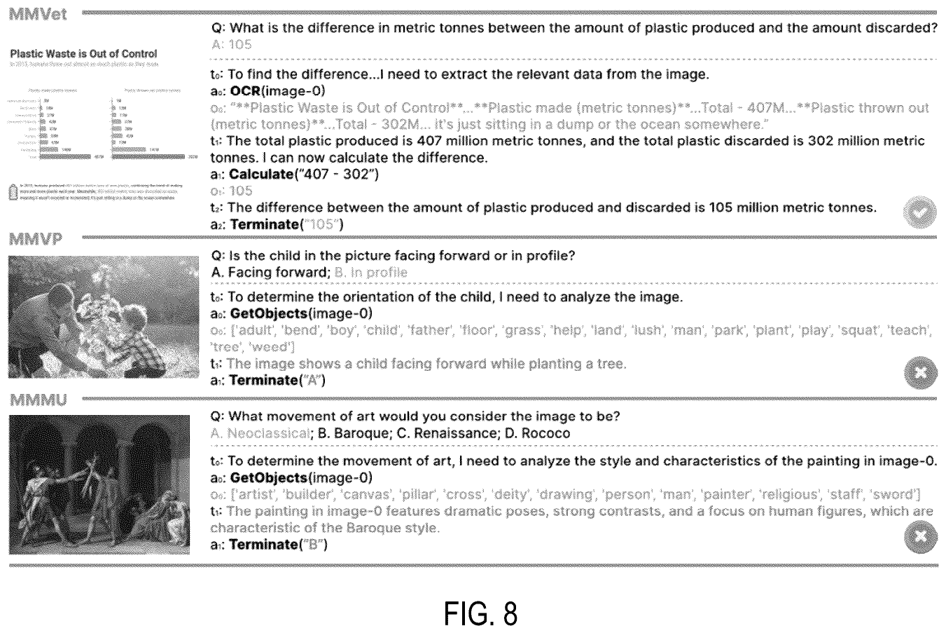

FIG. 8 demonstrate why CoTA data significantly improves performance on MMVet while potentially harming performance on MMVP and MMMU. The substantial gains on MMVet occur because this benchmark includes many questions involving OCR and math calculations that the model can answer correctly by calling OCR and CALCULATE actions. Conversely, performance decreases on MMVP and MMMU stem from the action space not covering tools that would directly benefit many questions in these datasets (such as orientation questions in MMVP and domain-specific questions in MMMU). In these cases, calling actions produces useless or even misleading outputs.

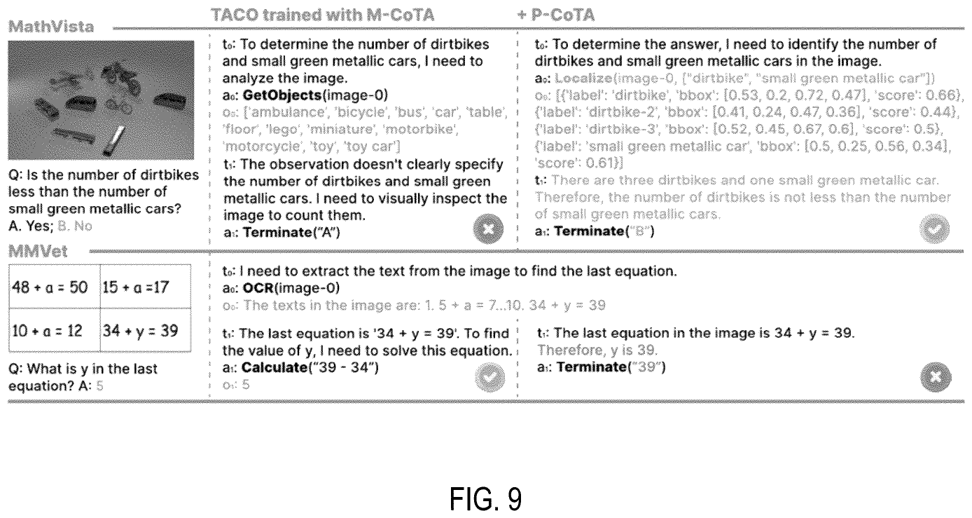

Table 4 and FIG. 9 show the effects of programmatic CoTA Data. Specifically, Table 4 reveals that adding programmatic CoTA data results in up to 3% gain on MathVista while causing a 9% drop on MMVet. FIG. 6 provides insight into this discrepancy: programmatic CoTA significantly improves the general VQA split in MathVista by almost 9% because LOCALIZE actions prove helpful for these questions. The programmatic data includes numerous LOCALIZE instances that enable TACO to learn to use this action effectively. However, the same programmatic data hurts performance on MMVet, likely due to the model's degraded reasoning ability resulting from the simple and rigid thought patterns generated with templates in the programmatic data.

These findings in Tables 1-4 and FIGS. 7-9 collectively indicate that both the quality of reasoning (thoughts) and the diversity of actions play crucial roles in model performance. Multi-modal models exhibit improved CoTA performance after training with the generated CoTA data.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training a neural network model for generating a response to a question based on an input image, the method comprising:
generating, by a multi-modal neural network model, chain-of-thoughts-and-action (CoTA) data corresponding to an image, a question relating to the image and a ground-truth answer,
wherein the CoTA data includes a sequence of steps for execution towards the ground-truth answer;
generating, by the multi-modal neural network model, a predicted answer based on an input of the image, the question and the CoTA data;
in response to determining that the predicted answer aligns with the ground-truth answer, parsing at least one step from the sequence of steps into a format of a thought element, an action element, and an observation element;
training the multi-modal neural network model using training data including the image, the question, the ground-truth answer and the CoTA data having the parsed at least one step; and
building an artificial intelligence (AI) agent based on the trained neural network model for performing one or more vision-language tasks.

2. The method of claim 1, further comprising:
generating, by the multi-modal neural network model, CoTA data or Chain-of-Thoughts (CoT) data depending on a type of the question,
wherein each step of the CoTA data comprises a respective thought of an explanation on what to do next, a respective action on how to implement the respective thought, and an observation of a computing environment after the respective action has been carried out, and
wherein each step of the CoT data comprises the respective thought and the respective action.

3. The method of claim 1, wherein the predicted answer is extracted from the CoTA data based on a final action indicator.

4. The method of claim 1, further comprising:
in response to determining that the predicted answer does not align with the ground-truth answer or the CoTA data fails to be parsed, excluding the CoTA data from the training data.

5. The method of claim 1, further comprising:
generating, by the multi-modal neural network model, annotations for the image, wherein the annotations comprise one or more of:
an object category, an object attribute, an inter-object relationship and a depth map.

6. The method of claim 5, further comprising:
generating, using a pre-defined template, a question-and-answer (QA) pair and corresponding CoTA data based on the annotations.

7. The method of claim 1, wherein the training the neural network model using training data comprises:
generating, by the multi-modal neural network model, predicted CoTA data that leads to a training answer based on a training input of the question and the image; and
training the multi-modal neural network model based on the predicted CoTA data and the CoTA data, and/or the training answer and the ground-truth answer.

8. A system for training a neural network model for generating a response to a question based on an input image, the system comprising:
a memory storing a multi-modal neural network model and a plurality of processor-executable instructions; and
one or more processors executing the plurality of processor-executable instructions to perform operations comprising:
generating, by a multi-modal neural network model, chain-of-thoughts-and-action (CoTA) data corresponding to an image, a question relating to the image and a ground-truth answer,
wherein the CoTA data includes a sequence of steps for execution towards the ground-truth answer;
generating, by the multi-modal neural network model, a predicted answer based on an input of the image, the question and the CoTA data;
in response to determining that the predicted answer aligns with the ground-truth answer, parsing at least one step from the sequence of steps into a format of a thought element, an action element, and an observation element;
training the multi-modal neural network model using training data including the image, the question, the ground-truth answer and the CoTA data having the parsed at least one step; and
building an artificial intelligence (AI) agent based on the trained neural network model for performing one or more vision-language tasks.

9. The system of claim 8, wherein the operations further comprise:
generating, by the multi-modal neural network model, CoTA data or Chain-of-Thoughts (CoT) data depending on a type of the question,
wherein each step of the CoTA data comprises a respective thought of an explanation on what to do next, a respective action on how to implement the respective thought, and an observation of a computing environment after the respective action has been carried out, and
wherein each step of the CoT data comprises the respective thought and the respective action.

10. The system of claim 8, wherein the predicted answer is extracted from the CoTA data based on a final action indicator.

11. The system of claim 8, wherein the operations further comprise:
in response to determining that the predicted answer does not align with the ground-truth answer or the CoTA data fails to be parsed, excluding the CoTA data from the training data.

12. The system of claim 8, wherein the operations further comprise:
generating, by the multi-modal neural network model, annotations for the image, wherein the annotations comprise one or more of:
an object category, an object attribute, an inter-object relationship and a depth map.

13. The system of claim 12, wherein the operations further comprise:
generating, using a pre-defined template, a question-and-answer (QA) pair and corresponding CoTA data based on the annotations.

14. The system of claim 8, wherein the operation of training the neural network model using training data comprises:
generating, by the multi-modal neural network model, predicted CoTA data that leads to a training answer based on a training input of the question and the image; and
training the multi-modal neural network model based on the predicted CoTA data and the CoTA data, and/or the training answer and the ground-truth answer.

15. A non-transitory processor-readable medium storing a plurality of processor-executable instructions for training a neural network model for generating a response to a question based on an input image, the instructions being executed by one or more processors to perform operations comprising:
generating, by a multi-modal neural network model, chain-of-thoughts-and-action (CoTA) data corresponding to an image, a question relating to the image and a ground-truth answer,
wherein the CoTA data includes a sequence of steps for execution towards the ground-truth answer;
generating, by the multi-modal neural network model, a predicted answer based on an input of the image, the question and the CoTA data;
in response to determining that the predicted answer aligns with the ground-truth answer, parsing at least one step from the sequence of steps into a format of a thought element, an action element, and an observation element;
training the multi-modal neural network model using training data including the image, the question, the ground-truth answer and the CoTA data having the parsed at least one step; and
building an artificial intelligence (AI) agent based on the trained neural network model for performing one or more vision-language tasks.

16. The non-transitory processor-readable medium of claim 15, wherein the operations further comprise:
generating, by the multi-modal neural network model, CoTA data or Chain-of-Thoughts (CoT) data depending on a type of the question,
wherein each step of the CoTA data comprises a respective thought of an explanation on what to do next, a respective action on how to implement the respective thought, and an observation of a computing environment after the respective action has been carried out, and
wherein each step of the CoT data comprises the respective thought and the respective action.

17. The non-transitory processor-readable medium of claim 15, wherein the predicted answer is extracted from the CoTA data based on a final action indicator.

18. The non-transitory processor-readable medium of claim 15, wherein the operations further comprise:
in response to determining that the predicted answer does not align with the ground-truth answer or the CoTA data fails to be parsed, excluding the CoTA data from the training data.

19. The non-transitory processor-readable medium of claim 15, wherein the operations further comprise:
generating, by the multi-modal neural network model, annotations for the image, wherein the annotations comprise one or more of:
an object category, an object attribute, an inter-object relationship and a depth map.

20. The non-transitory processor-readable medium of claim 15, wherein the operations further comprise:
generating, using a pre-defined template, a question-and-answer (QA) pair and corresponding CoTA data based on the annotations.
